(19) United States
(12) Patent Application Publication
(10) Pub. No.: US 2011/0176715 A1
(43) Pub. Date: Jul. 21, 2011

(54) FOUR-DIMENSIONAL VOLUME IMAGING SYSTEM

(76) Inventors: David H. Foos, Rochester, NY (US); Jeffrey H. Siewerdsen, Baltimore, MD (US); John Yorkston, Penfield, NY (US); Dong Yang, Rochester, NY (US)

(21) Appl. No.: 12/971,042

(22) Filed: Dec. 17, 2010

Related U.S. Application Data
(60) Provisional application No. 61/296,898, filed on Jan. 21, 2010.
(60) Provisional application No. 61/307,057, filed on Feb. 23, 2010.
(60) Provisional application No. 61/412,853, filed on Nov. 12, 2010.

(51) Int. Cl. G06K 9/00

(52) U.S. Cl. 382/131; 382/154

(57) ABSTRACT

A method for obtaining a 3-D image. An initial volume image is obtained of a subject wherein the subject is stationary and in a first pose. One or more 2-D images of the subject are obtained as the subject is moving between the first pose and a second pose. An endpoint volume image of the subject with the subject stationary and in the second pose is obtained. At least the initial volume image is modified according to the one or more obtained 2-D images to form at least one intermediate volume image that is representative of the subject's position between the first and second pose. The at least one intermediate volume image can be displayed.

### CROSS REFERENCE TO RELATED APPLICATIONS

Reference is made to and priority claimed from U.S. Ser. No. 61/296,898, provisionally filed on Jan. 21, 2010 and entitled: VIRTUAL FOUR DIMENSIONAL CONE BEAM COMPUTED TOMOGRAPHY SYSTEM, in the name of David H. Foos et al.

Reference is made to and priority claimed U.S. Ser. No. 61/307,057, provisionally filed on Feb. 23, 2010 and entitled: FOUR-DIMENSIONAL VOLUME IMAGING SYSTEM, in the name of David H. Foos et al.

Reference is made to and priority claimed U.S. Ser. No. 61/412,853, provisionally filed on Nov. 12, 2010 and entitled: FOUR-DIMENSIONAL VOLUME IMAGING SYSTEM, in the name of David H. Foos et al.

### FIELD OF THE INVENTION

The invention relates generally to the field of volume imaging and more particularly to a method for providing a motion image sequence of a 3-D volume image for diagnostic or other purposes.

### BACKGROUND OF THE INVENTION

3-D volume imaging has proved to be a valuable diagnostic tool that offers significant advantages over earlier 2-D radiographic imaging techniques for evaluating the condition of internal structures and organs. 3-D imaging of a patient or other subject has been made possible by a number of advancements, including the development of high-speed imaging detectors, such as digital radiography (DR) detectors that enable multiple images to be taken in rapid succession.

Cone beam computed tomography (CBCT) or cone beam CT technology offers considerable promise as one type of diagnostic tool for providing 3-D volume images. Cone beam CT systems capture volumetric data sets by using a high frame rate flat panel digital radiography (DR) detector and an x-ray source affixed to a gantry that rotates about the object to be imaged. The CBCT system captures projections throughout the rotation, for example, one 2-D projection image at every degree of rotation. The projections are then reconstructed into a 3D volume image using various techniques. Among the most common methods for reconstructing the 3-D volume image are filtered back projection approaches.

One limitation of CBCT and other volume imaging technologies is that, for most applications, these technologies provide only still images, that is, images with the patient or other subject held in a stationary position. For some medical applications, such as for diagnosing the condition of joints such as knees, shoulders, and ankles, for example, there would be significant clinical value in the capability to reconstruct the 3-D volume image in motion. Such an image would be used, for example, by an orthopaedic physician for diagnostic functions such as preoperative planning or for assessing healing and recovery after surgery. Other applications that would benefit from the capability to obtain 3-D volume images in motion include dental and veterinary imaging and non-destructive testing (NDT), for example. Currently there are no practical methods available for producing a radiographic motion sequence in three dimensions. Conventional methods such as continuously obtaining volume images of a moving subject not only require significant expenditure of equipment time and of computing and image processing resources, but these methods can cause movement to be artificially constrained, such as slowed to a very low speed. Furthermore, for medical diagnostic imaging, the cumulative radiation exposure levels needed to provide enough images for a 3-D motion image sequence can be unacceptable with such a continuous volume imaging approach.

Thus, while there is considerable value in conventional volume imaging using DR capabilities, there is a need for the enhanced capability to provide a time-sequenced fourth dimension that allows the diagnostician to view volume images of the patient in motion.

### SUMMARY OF THE INVENTION

It is an object of the present invention to advance the art of diagnostic volume imaging by providing a motion sequence that includes a number of 3-D volume images, but without the requirement to obtain all of the 3-D volume images in the sequence using the full 3-D exposure and image processing procedure.

These objects are given only by way of illustrative example, and such objects may be exemplary of one or more embodiments of the invention. Other desirable objectives and advantages inherently achieved by the disclosed invention may occur or become apparent to those skilled in the art.

It is an advantage of the present invention that it provides a motion sequence that shows movement of a subject in 3-D, without requiring new hardware in addition to that already provided in existing volume imaging apparatus. Thus, the 3-D motion sequence is obtained using image processing software rather than using more costly imaging equipment.

According to one aspect of the present invention there is provided a method for obtaining a 3-D image, the method executed at least in part on a computer system and comprising: obtaining an initial volume image of a subject with the subject stationary and in a first pose; obtaining one or more 2-D images of the subject, as the subject is moving between the first pose and a second pose; obtaining an endpoint volume image of the subject with the subject stationary and in the second pose; modifying at least the initial volume image according to the one or more obtained 2-D images to form at least one intermediate volume image that is representative of the subject position between the first and second pose; and displaying the at least one intermediate volume image.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a schematic diagram that shows the activity of a CBCT imaging apparatus for obtaining the individual 2-D images that are used to form a 3-D volume image.

FIG. 2 is a schematic diagram that shows an imaging sequence for obtaining images needed for reconstruction of a motion 3-D volume image according to an embodiment of the present invention.

FIG. 3 is a schematic diagram that shows how the imaging sequence of FIG. 2 is used to form intermediate volume images for a timed-sequence 4-D presentation.

FIG. 4 is a logic flow diagram that shows the sequence of steps used to obtain the image data used for a timed-sequence 4-D presentation.

FIG. 5 is a logic flow diagram that shows the sequence of steps used to generate intermediate 3-D images to be used as part of the motion sequence in one embodiment.

FIG. 6A is a top view that shows schematically one arrangement of the digital detector in a sequence for obtaining 2-D images used to form the intermediate 3-D images of the motion sequence.

FIG. 6B is a top view that shows schematically an alternate arrangement of the digital detector in a sequence for obtaining 2-D images used to form the intermediate 3-D images of the motion sequence.

FIG. 6C is a top view that shows schematically another alternate arrangement of the digital detector for obtaining 2-D images in a sequence used to form the intermediate 3-D images of the motion sequence.

FIG. 6D is a top view that shows schematically yet another alternate arrangement of the digital detector in a sequence for obtaining 2-D images used to form the intermediate 3-D images of the motion sequence.

FIG. 6E is a top view that schematically shows an alternative imaging sequence in which an additional volume image is obtained at some point in the image capture sequence between the initial and endpoint volume images.

FIG. 7 is a schematic side view showing the use of fiducials in obtaining the 2-D images used to form the intermediate 3-D images of the motion sequence.

FIG. 8 is a schematic side view showing the use of a guide for guiding the movement of a subject in one embodiment.

### DETAILED DESCRIPTION OF THE INVENTION

The following is a detailed description of the preferred embodiments of the invention, reference being made to the drawings in which the same reference numerals identify the same elements of structure in each of the several figures.

In the context of the present disclosure, the phrase “timed-sequence 4-D presentation” is functionally equivalent to the phrase “3-D motion image”. The three dimensions relate to the conventional orthogonal vectors used to define a volume 3-D image, typically expressed and represented along three orthogonal x, y, and z axes. The fourth dimension is time.

The apparatus and method of the present invention are described with reference to a CBCT imaging system and sequence. Advantageously, the method of the present invention can be carried out using existing CBCT imaging equipment, with some needed modifications to the conventional imaging sequence used for CBCT imaging. However, it must be emphasized that the methods and procedures described herein could be used in a similar way with other types of imaging systems that generate 3-D volume images. The method of the present invention combines 3-D volume image data obtained from an imaging system with 2-D image data obtained from the same system or obtained from alternate imaging systems and equipment. The 2-D image data provides time- and motion-related information that is used to modify the 3-D volume image data in order to provide a 3-D motion image. The resultant 3-D motion image is alternately termed a “4-D” image, wherein the fourth dimension relates to time.

CBCT imaging apparatus and the imaging algorithms used to obtain 3-D volume images using such systems are well known in the diagnostic imaging art and are, therefore, not described in detail in the present application. Some exemplary algorithms for forming 3-D volume images from the source 2-D images that are obtained in operation of the CBCT imaging apparatus can be found, for example, in U.S. Pat. No. 5,999,587 entitled “Method of and System for Cone-Beam Tomography Reconstruction” to Ning et al. and in U.S. Pat. No. 5,270,926 entitled “Method and Apparatus for Reconstructing a Three-Dimensional Computerized Tomography (CT) Image of an Object from Incomplete Cone Beam Data” to Tam. In typical applications, a computer or other type of dedicated logic processor for obtaining, processing, and storing image data is part of the CBCT system, along with one or more displays for viewing image results.

Advantageously, the method of the present invention does not require development of particular or CBCT systems or other imaging apparatus that are dedicated to the 4-D imaging function, but can be used with existing imaging systems of various types. The method of the present invention employs an enhanced imaging sequence in order to obtain the 3-D motion image, as described in more detail subsequently.

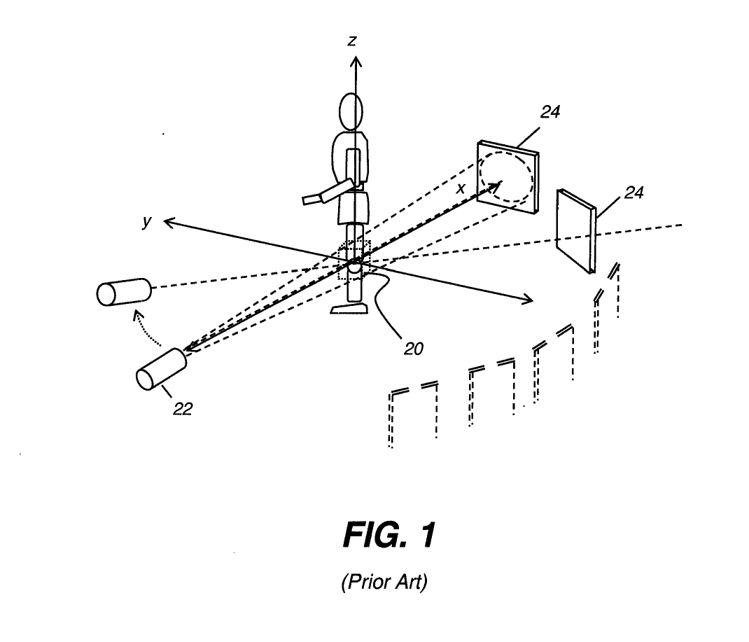

Referring to the schematic diagram of FIG. 1, the activity of a conventional CBCT imaging apparatus for obtaining the individual 2-D images that are used to form a 3-D volume image is shown in simplified form. A cone-beam radiation source 22 directs a cone of radiation toward a subject 20, such as a patient or other subject for which motion imaging is needed. A sequence of images is obtained in rapid succession at varying angles about the subject, such as one image at each 1-degree angle increment in a 360-degree rotation. A DR detector 24 is moved to different imaging positions about subject 20 in concert with corresponding movement of radiation source 22. FIG. 1 shows a representative sampling of DR detector 24 positions to illustrate how these images are obtained relative to the position of subject 20. Once the needed 2-D projection images are captured in this sequence, a suitable imaging algorithm, such as filtered back projection or other conventional technique, is used for generating the 3-D volume image.

As noted previously in the background section, the 3-D volume image that is conventionally obtained by the CBCT imaging apparatus is a still image. Subject 20 is in a fixed pose, constrained from any movement that would hinder the task of reconstructing the volume image from the numerous individual 2-D projection images.

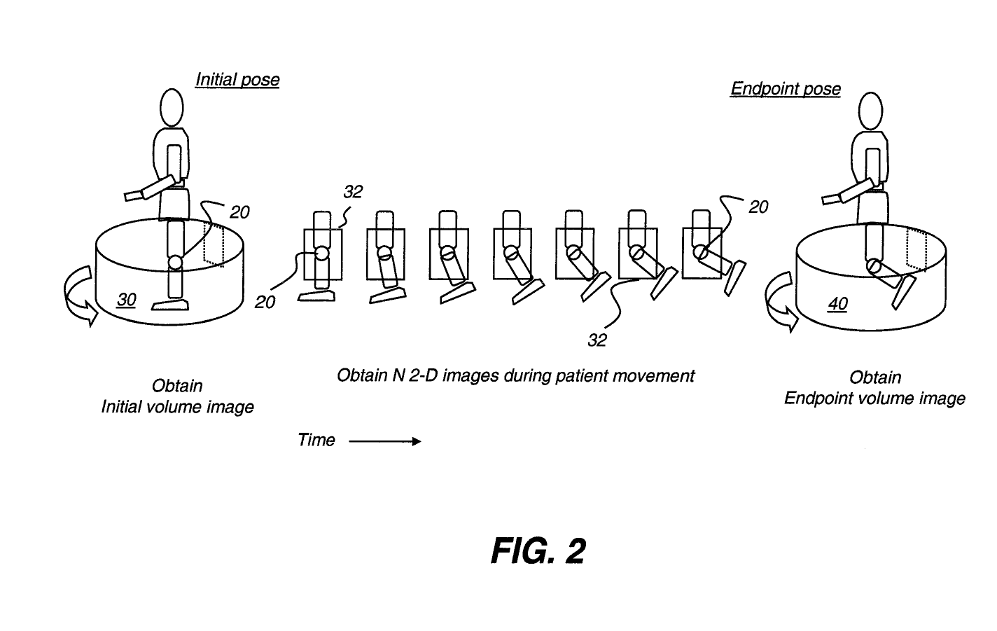

The method of the present invention enhances the capability of the CBCT system to capture additional 2-D images that can then be used to reconstruct a 3-D motion image, thereby forming a 4-D image. Referring to the schematic diagram of FIG. 2, there is shown a sequence for generating the 3-D motion image. In the examples that follow, the sequence for obtaining a 3-D motion image of the human knee is used as an example to illustrate the procedures of the present invention. It can be appreciated that a similar sequence can be used for imaging other subjects, including imaging other limbs or portions of the human anatomy as well as for imaging other animate or inanimate subjects for which movement analysis is useful. As noted in previously in the background section, the method of the present invention can be used, for example, in non-destructive testing (NDT), dental imaging, or veterinary imaging, as well as in medical diagnostic imaging applications.

In the sequence of FIG. 2, with time represented from left to right, an initial volume image 30 is first obtained using a CBCT imaging sequence, as was described with reference to FIG. 1. For obtaining this image, subject 20 is stationary in an initial pose, shown at the left. Then, in rapid succession, a series of N sequential 2-D images 32, such as a series of individual x-ray 2-D projection images, is captured while subject 20 is moved from the initial pose position to another stationary pose at a final or endpoint position. In the example of FIG. 2, the patient knee is flexed from an initial to an endpoint position as the 2-D images 32 are obtained. The rate of image capture for 2-D images 32 can be varied to a suitable value over a range, such as 10 or 20 or 30 images per second, for example. To terminate this image capture sequence, an endpoint volume image 40 is obtained using the CBCT system, again with subject 20 stationary and in the endpoint pose.

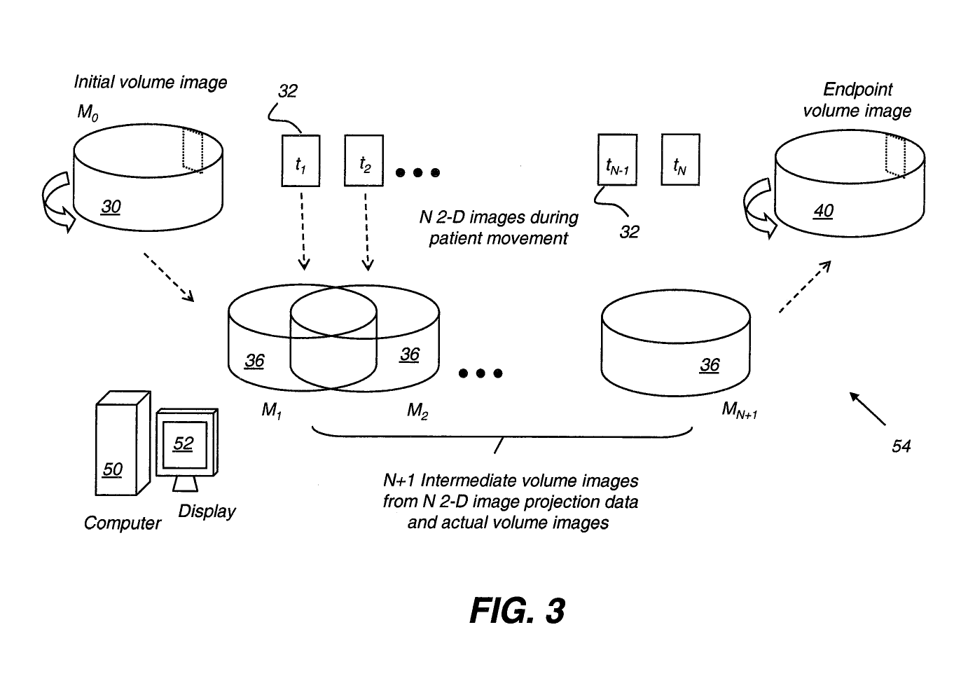

The schematic diagram of FIG. 3 shows a processing sequence for the imaging results that are obtained using the sequence of FIG. 2. Processing is executed on a computer 50, which may be any of a number of types of computer, computer workstation, microprocessor, dedicated host processor, networked processor or processors, or other logic processing apparatus. Associated with computer 50 either as part of the computer hardware or as a separate component is an electronic memory that provides image storage and workspace for data manipulation operations. A computer program product that executes this method may include one or more storage media, for example; magnetic storage media such as magnetic disk or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention. A display 52 is associated with computer 50 and can be used to enter operator commands that initiate and control the processing sequence of FIG. 3 and to display processing results, such as displaying a motion 3-D image that has been generated according to the present invention.

Following the sequence of FIG. 3, beginning with initial volume image 30, a succession of intermediate volume images 36 are generated using the movement information obtained from the succession of 2-D images 32. Notation t₁, t₂, t_{N} is used herein to represent the ordered sequence of 2-D images 32 captured at corresponding times t₁, t₂, t_{N}. The resulting 3-D motion image that is assembled using this processing, shown as an ordered sequence of 3-D images 54, corresponds to the ordered sequence that begins with initial volume image 30 and includes each intermediate volume image 36 in sequence, terminating with endpoint volume image 40. This 3-D motion image can be stored in an electronic computer-accessible memory that is part of or otherwise associated with computer 50 and can be rendered for viewing, such as on a high resolution display monitor.

Once the intermediate volume images 36 are formed, image manipulation techniques can be used on the resulting 3-D volume data, such as digitally reconstructed radiography (DRR) that enables a 2-D image to be extracted from the reconstructed volume image. DRR methods and techniques for 2-D image extraction are familiar to those skilled in the volume imaging arts.

Advantageously, ordered sequence of 3-D images 54 consisting of initial volume image 30, the N+1 intermediate volume images 36 in order, and endpoint volume image 40, or a subset of these volume images, can be stored and played back and replayed at an appropriate speed, paused, and played in reverse. Initial and endpoint volume images 30 and 40 as well as the individual intermediate volume images 36 can be individually viewed at suitable angles and used for diagnostic purposes. Using the example of a knee as object 20, animated playback of the ordered sequence of 3-D images obtained as shown in FIG. 3 allows a practitioner to observe joint movement from any suitable angle, such as to observe knee function in motion from side, front, and rear views, for example.

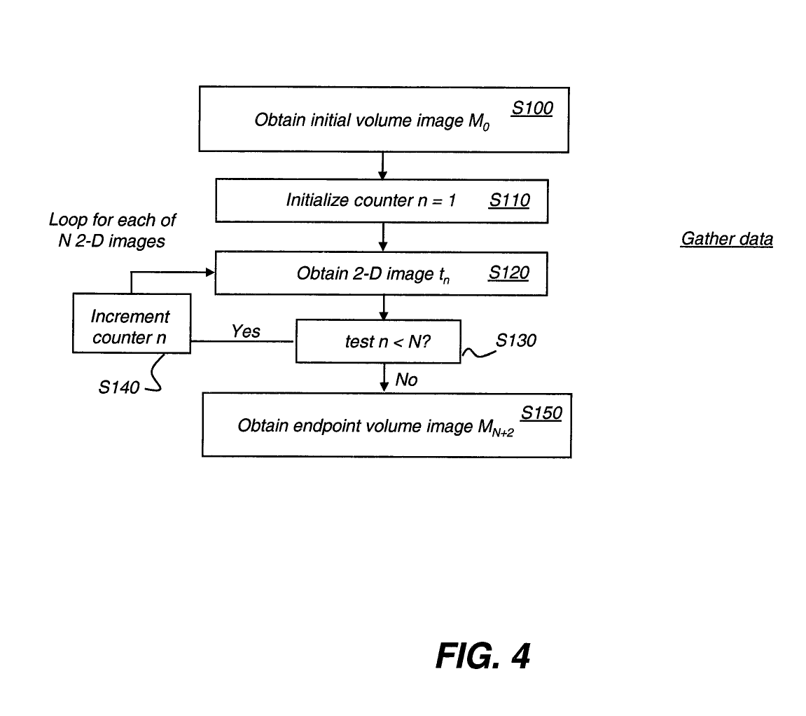

FIG. 4 is a logic flow diagram that shows an exemplary sequence of steps for gathering the image data used for a timed-sequence 4-D presentation, following the pattern described with reference to FIG. 2. An initial step S100 obtains the initial volume image M₀. Following this, a repeated sequence then acquires the N 2-D projection images, shown as a looping operation in FIG. 4. A counter initialization step S110 initializes a counter value n to control loop repetition and exit. Each 2-D projection image tₙ is captured in an acquisition step S120. A test step S130 and loop counter increment step S140 are then executed for loop control. Finally, an endpoint volume image acquisition step S150 obtains endpoint volume image 40.

Referring back to FIG. 3, it can be appreciated that the number N of 2-D images 32 that are needed can be based on various factors, such as the complexity of the subject 20, the relative speed of motion that is to be captured, the response time of the DR detector 24, and other factors. Likewise, the interval between times tₙ can vary. It may be advantageous to vary the interval timing between capture for any two 2-D images 32 in the series based on factors such as a specific relationship of features of subject 20 during movement, for example.

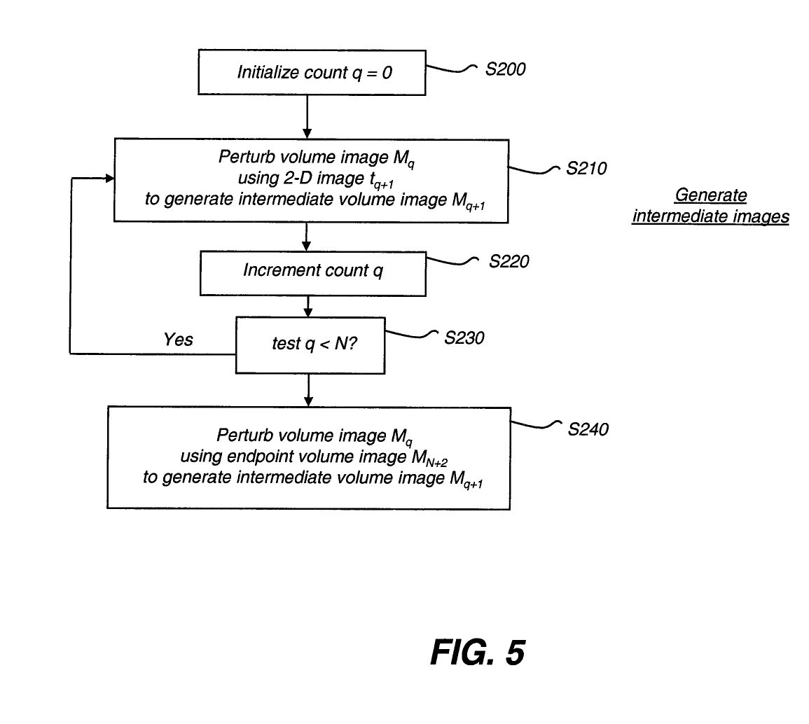

Given the data gathered using the sequence of steps in FIG. 4, the logic flow diagram of FIG. 5 shows an exemplary sequence of steps used to generate N+1 intermediate 3-D volume images 36 to be used as part of the motion sequence, as described previously with reference to FIG. 3, in one embodiment. A loop initialization step S200 resets a count value q for controlling the repeated sequence that follows. A perturbation step 5210 then modifies volume image M_{q} using relative motion data obtained from 2-D projection image taken at t_{q+1} to generate each of the successive intermediate 3-D volume images 36. An increment step S220 and test step S230 then perform loop repetition and exit, repeating perturbation step S210 as many times as needed for generating the N+1 intermediate 3-D volume images 36. Lastly, a terminal step 5240 performs the modification of intermediate 3-D volume image M_{q} using endpoint volume image M_{N+2} in order to generate the last intermediate 3-D volume image in the series, M_{N+1}.

It is to be noted that the logic flow shown in FIGS. 4 and 5 is exemplary, provided to show the sequence of steps for one embodiment of the present invention; other sequences could be used to provide a similar result. Various techniques for combining the data from multiple 2-D images 32 could be used for obtaining the data needed to perform the needed 3-D perturbation, for example. Motion prediction techniques may benefit from combining a number of 2-D projection images, such as to provide suitable motion vectors for example.

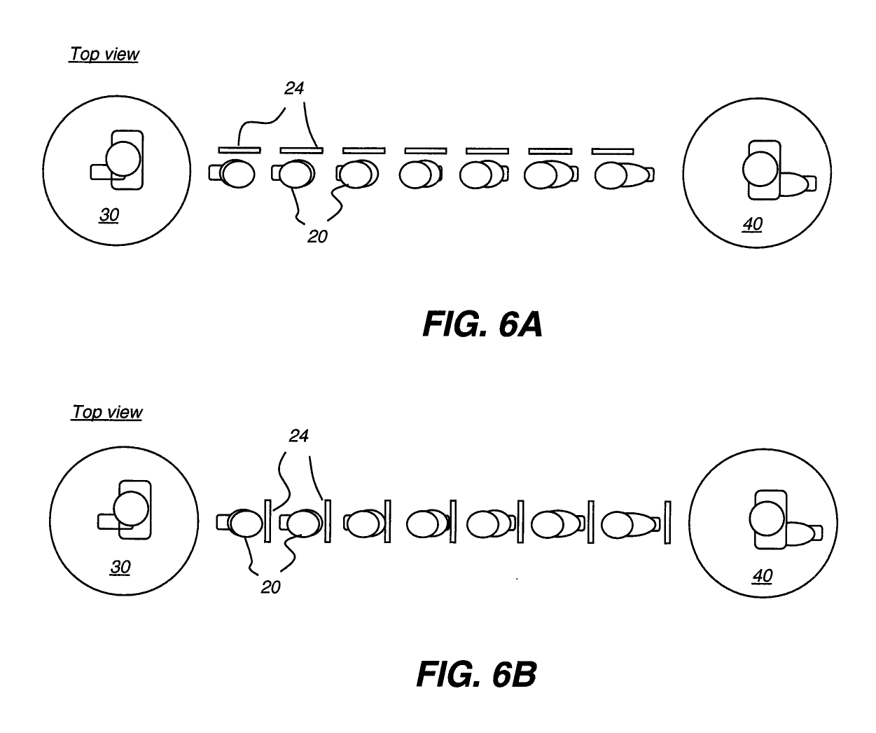

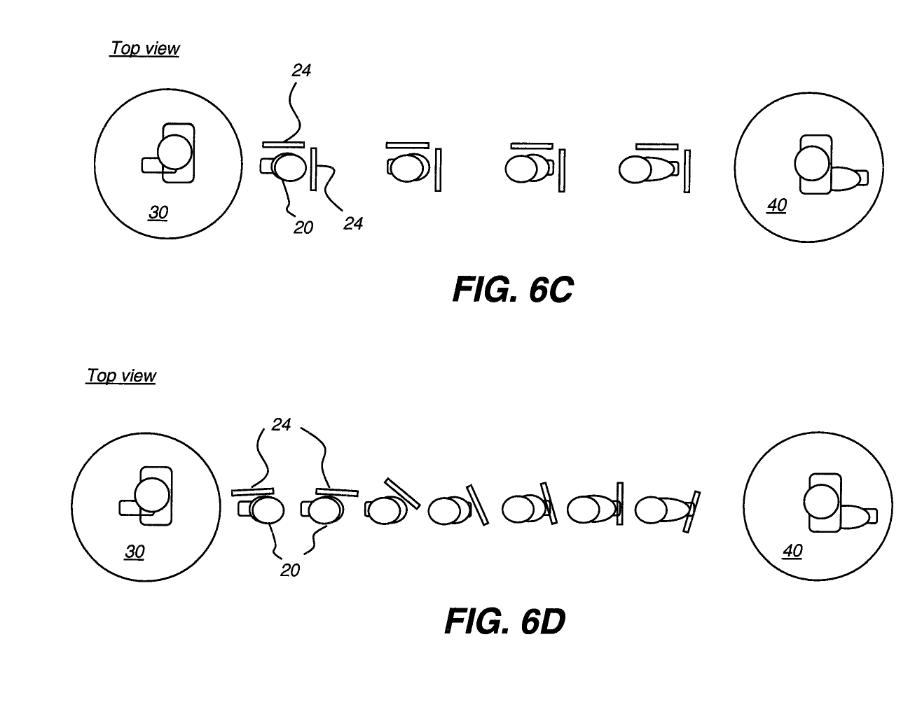

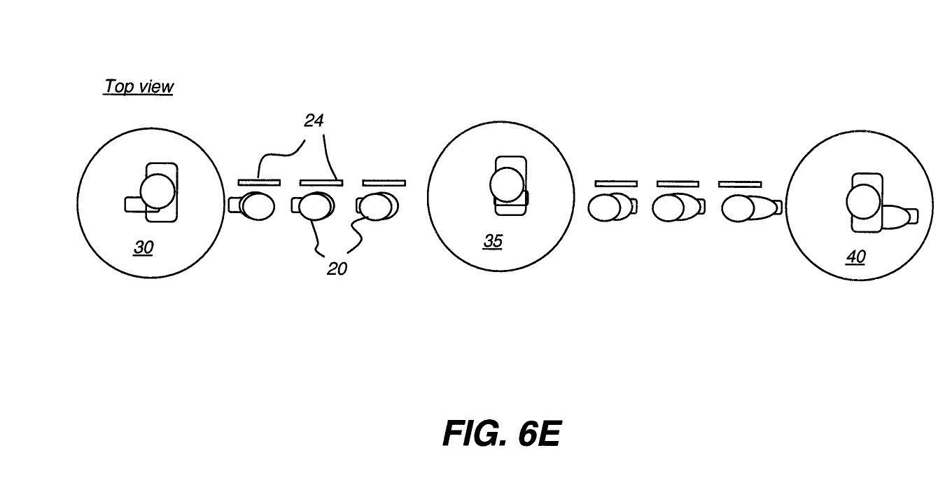

FIGS. 6A, 6B, 6C, and 6D are top views that show schematically some of the possible imaging sequence arrangements. Each of the arrangements shown in these figures employs the digital radiography detector 24 with a different spatial orientation about the patient for obtaining 2-D images 32 used to form intermediate 3-D volume images of the motion sequence, as described earlier with reference to FIGS. 3 and 4. The knee of a patient is again represented as subject 20, in a cutaway section top view during movement between initial and endpoint poses of initial and endpoint volume images 30 and 40. In the FIG. 6A arrangement, DR detector 24 is maintained in a fixed position to provide a side view of subject 20 at each intermediate position. The FIG. 6B arrangement shows DR detector 24 maintained in an alternate front-to-back position for knee imaging. In the FIG. 6C arrangement, two DR detectors 24 are used and 2-D projection images are taken from the side and from the front, such as simultaneously. In the FIG. 6D arrangement, a circular arc scanning pattern is provided, moving DR detector 24 in an arc for obtaining a the 2-D images 32 in a sequence of views from different angles as subject 20 is moved.

FIG. 6E is a top view that schematically shows an alternative imaging sequence in which an additional volume image 35 is obtained at a third pose position that comes between the first and second poses that begin and end the motion sequence. This alternate sequence can be helpful, for example, where motion during some portion of the sequence is of particular interest.

It can be appreciated that the example arrangements of FIGS. 6A-6E are non-limiting, but are given in order to illustrate some of the various orientations and sequence variations that can be used for obtaining the 2-D image projections between initial volume image 30 and endpoint volume image 40. Selection of a suitable arrangement for an application can be based on factors such as optimal angle for obtaining motion information during part of the movement cycle, such as during knee flexure as shown. For knee movement, for example, 2-D projection images obtained from a particular angle may provide the most useful data for performing the perturbations that form the intermediate volume images, relative to a region of interest. Accessibility and other factors may also dictate which type of arrangement of DR detector 24 is most useful in a given application.

As has been noted, CBCT imaging is only one type of image modality for which the 3-D motion sequence can be used. The 3-D volume data that is obtained for initial and endpoint images 30 and 40, as well as for any additional volume images 35, can alternately be obtained on some other type of volume imaging system, including an apparatus that uses Magnetic Resonance Imaging (MRI), ultrasound volume imaging, Positron Emission Tomography (PET), Magnetic Particle Imaging (MPI), Single Photon Emission Computed Tomography (SPECT), or some other volume imaging technique. With respect to FIG. 6E, for example, volume images 30, 35, and 40 can be obtained on a single imaging system or on two or more different volume imaging apparatus.

Similarly, a number of 2-D imaging modalities can be utilized in addition to the use of a digital radiography (DR) detector as with the CBCT system of FIG. 1. Some of the 2-D imaging modalities that can provide suitable image data for the method of the present invention include 2-D x-ray imaging and ultrasound imaging, for example. In addition, visible light and infrared images can alternately be used as 2-D images. For example, a visible light image obtained using a suitably positioned camera may provide sufficient information for use in modifying one or more volume images. In addition, more than one 2-D imaging modality can be used for 2-D image 32. Thus, with respect to FIG. 3, a number of suitable 2-D imaging modalities can be used, in various combinations, to provide 2-D images 32 during patient movement at times t₁, t₂, . . . t_{N}.

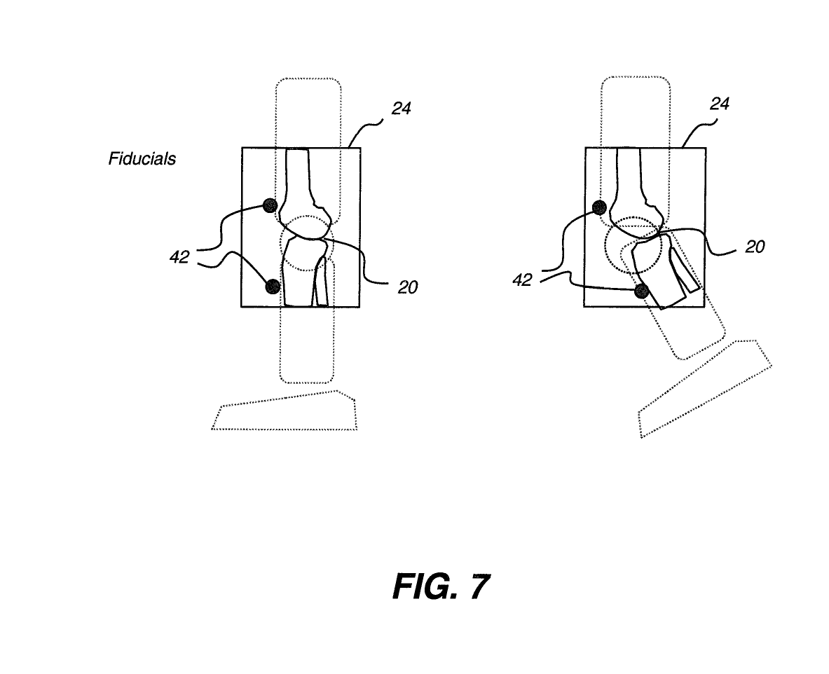

Various spatial reference points may also help in the task of volume image reconstruction from 2-D images 32. FIG. 7 is a schematic side view showing the use of fiducial elements 42 in obtaining the 2-D images 32 used to form the intermediate 3-D images of the motion sequence. Various types and arrangements of fiducial elements 42 can be associated with subject 20, again depending on the subject 20 that is being imaged and on the relative orientation of DR detector 24 for each portion of the imaging sequence. A fiducial element 42 could be highly dense or have a distinctive appearance when imaged. Fiducial elements 42 could be taped to the patient or other subject 20 or fastened to a suitable surface in some way. A brace or other type of device could also be used for this purpose. Alternately, an implanted object or an applied or injected substance could be used as a fiducial element.

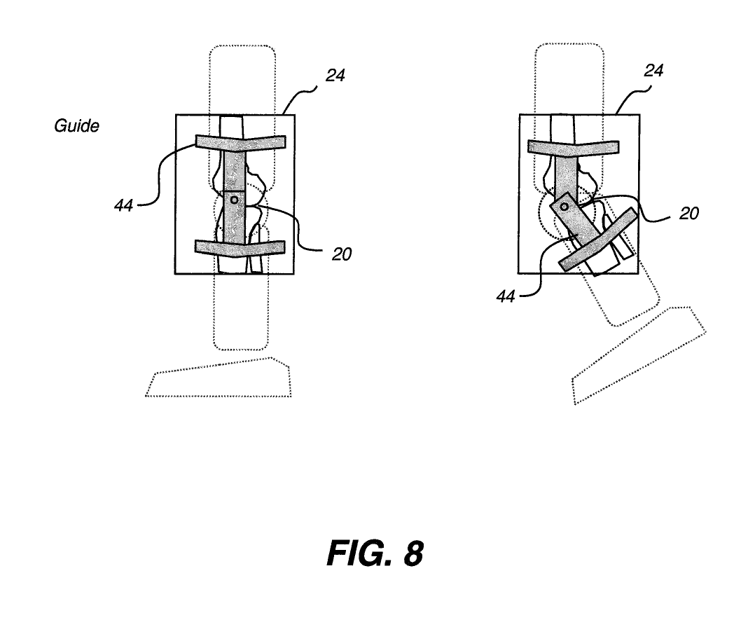

Another helpful accessory for obtaining a 3-D motion sequence is a device for providing guidance so that movement is performed along a preferred path. FIG. 8 is a schematic side view showing the use of a guide 44 for guiding the movement of a subject in one embodiment. Guide 44 in this example is represented as a type of hinged brace. Alternative guide mechanisms can be used. Guide 44 may also be used to control the speed of movement of the imaged subject 20.

Perturbation of the 3-D volume images based on data obtained from 2-D projection images is an interpolation problem that can be addressed using various techniques known to those skilled in the 3-D image reconstruction art. As the sequence of FIG. 5 shows, the 2-D projection image data provides a constraint for adjusting the position of features within the intermediate volume image. Overall, the problem of image interpolation is at least somewhat closely related to the set of problems that are solved for reconstruction in initially forming the 3-D volume image from its original 2-D data.

Various techniques can be used for correlating the 2-D image data to the 3-D image volume for performing the needed interpolation. For example, maximized mutual information is one approach used for relating a coordinate system of an image to a reference image, iteratively deforming the image until mutual information between it and the reference image is maximized. The use of mutual information for image registration is described, for example, in commonly assigned U.S. Pat. No. 7,263,243 entitled “METHOD OF IMAGE REGISTRATION USING MUTUAL INFORMATION” to Chen et al.

3-D image morphing utilities and techniques, familiar to those skilled in image metamorphosis, can be adapted to the problem of generating intermediate volume images 36 as a type of 3-D image morphing process. Among examples of tools and approaches for volume image morphing and warping are those described by researchers Apostolos Lerios, Chase D. Garfinkle, and Marc Levoy in “Feature-Based Volume Metamorphosis”, presented in the Proceedings of the 22nd annual Conference on Computer Graphics and Interactive Techniques (1995), pp 449-456. An example of techniques and approaches for volume morphing and deformation of a 3-D object when tracking the object in a sequence of images is given in U.S. Pat. No. 7,006,683 entitled “MODELING SHAPE, MOTION, AND FLEXION OF NON-RIGID 3D OBJECTS IN A SEQUENCE OF IMAGES” to Brand.

A considerable amount of data storage space can be required for storing the ordered sequence of 3-D images that have been obtained as described herein. Various image modeling techniques can be used to reduce the overall amount of data that would need to be stored in order to provide each of the N+3 volume images that are generated.

In the following description, a preferred embodiment of the present invention will be described as a software program. Those skilled in the art will recognize that the equivalent of such software may also be constructed in hardware. Because image manipulation algorithms and systems are well known, the present description will be directed in particular to algorithms and systems forming part of, or cooperating more directly with, the method in accordance with the present invention. Other aspects of such algorithms and systems, and hardware and/or software for producing and otherwise processing the image signals involved therewith, not specifically shown or described herein may be selected from such systems, algorithms, components and elements known in the art.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The methods described above may be described with reference to a flowchart. Describing the methods by reference to a flowchart enables one skilled in the art to develop such programs, firmware, or hardware, including such instructions to carry out the methods on suitable computers, executing the instructions from computer-readable media. Similarly, the methods performed by the service computer programs, firmware, or hardware are also composed of computer-executable instructions.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. A method for obtaining a 3-D image, the method executed at least in part on a computer system, comprising:
obtaining an initial volume image of a subject wherein the subject is stationary and in a first pose;
obtaining one or more 2-D images of the subject as the subject is moving between the first pose and a second pose;
obtaining an endpoint volume image of the subject wherein the subject is stationary and in the second pose;
modifying at least the initial volume image according to the one or more obtained 2-D images to form at least one intermediate volume image that is representative of the subject between the first and second pose; and
displaying the at least one intermediate volume image.

2. The method of claim 1 further comprising modifying the at least one intermediate volume image according to the one or more obtained 2-D images.

3. The method of claim 1 wherein obtaining the initial volume image comprises reconstructing the initial volume image from a cone-beam CT imaging system.

4. The method of claim 1 wherein the initial volume image is obtained from an imaging system taken from the group consisting of a magnetic resonance imaging system, an ultrasound volume imaging system, a positron emission tomography system, a magnetic particle imaging system, and a single photon emission computed tomography system.

5. The method of claim 1 wherein obtaining the one or more 2-D images of the subject comprises obtaining one or more of a 2-D x-ray image, an ultrasound image, a visible light image, and an infrared image.

6. The method of claim 1 further comprising obtaining a third volume image wherein the subject is stationary at an intermediate pose that is intermediate the first pose and the second pose.

7. The method of claim 1 wherein modifying the initial volume image comprises interpolation.

8. The method of claim 1 further comprising associating one or more fiducial elements with the subject.

9. The method of claim 8 wherein the one or more fiducial elements comprise an injected substance.

10. The method of claim 1 further comprising providing a guide for movement of the subject.

11. The method of claim 1 wherein displaying the at least one intermediate volume image further comprises displaying a sequence of images in succession, beginning with the initial volume image, including the at least one intermediate volume image, and ending with the endpoint volume image.

12. The method of claim 1 wherein the at least one intermediate volume image is a first intermediate volume image and wherein there is at least a second intermediate volume image and wherein the second intermediate image is formed by modifying the first intermediate volume image according to the one or more obtained 2-D images.

13. The method of claim 12 wherein there is a third intermediate volume image and wherein the third intermediate image is formed by modifying the second intermediate volume image according to the endpoint volume image.

14. The method of claim 1 further comprising storing the at least one intermediate volume image in a computer-accessible memory.

15. The method of claim 1 wherein obtaining the endpoint volume image comprises reconstructing the endpoint volume image from a cone-beam CT imaging system.

16. A computer storage medium having instructions stored therein for causing a computer to perform the method of claim 1.
